(19) United States
(12) Patent Application Publication
(10) Pub. No.: US 2003/0214388 A1
(43) Pub. Date: Nov. 20, 2003

(54) RFID deployment system

(76) Inventors: James Riley Stuart, Louisville, CO (US); Thomas Nello Giaccherini, Carmel Valley, CA (US)

Correspondence Address: Giaccherini, Post Office Box 1146, Carmel Valley, CA, 93924, US

(21) Appl. No.: 10/171,801

(22) Filed: Jun. 14, 2002

Related U.S. Application Data
(63) Continuation-in-part of application No. 10/151,470, filed on May 20, 2002.

(51) Int. Cl. G08B 13/14

(52) U.S. Cl. 340/10.1; 340/572.8

(57) ABSTRACT

The present invention comprises methods and apparatus for applying radio frequency identification devices or other integrated circuits to substrates like sheets of paper, labels or other surfaces or materials.

### CROSS-REFERENCE TO A RELATED PATENT APPLICATION & CLAIM FOR PRIORITY

The present Patent Application is a Continuation-in-Part Patent Application. The Applicants hereby claim the benefit of priority under Sections 119 & 120 of Title 35 of the United States Code of Laws for any subject matter presented in this Application and in a pending parent application Ser. No. 10/151,470 filed on May 20, 2002, entitled Inventory & Location System.

### FEDERALLY SPONSORED RESEARCH OR DEVELOPMENT

None.

### FIELD OF THE INVENTION

The present invention pertains to methods and apparatus for inventory management, asset tracking and building marketing databases. More particularly, one preferred embodiment of the invention utilizes various deployment means for wireless, passive radio frequency identification “RFID” devices. These devices work together with database software to provide a novel business or household inventory management system.

### BACKGROUND OF THE INVENTION

The business of managing and tracking assets and goods using passive, wireless radio frequency identification device (RFID) equipment is just beginning to find application in commercial markets. In general, an RFID is a passive device which emits a response when it is in the presence of an electromagnetic field. These generally small, thin, planar devices may be configured so that each RFID will emit a unique response when illuminated with a particular radio frequency signal. Over the past few decades, RFIDs have been used in combination with labels pasted to the inside covers of books to control the flow of library books. Many items sold by retailers, including articles of clothing and digital recordings like CDs and DVDs are protected with RFIDs that are stuck onto packaging that enclose the recordings.

Several companies run websites which contain information about RFIDs. Some examples are www.hitachi.com www.philips.com and www.alientechnology.com.

While RFIDs have been proposed for use in some warehouse or institutional settings to track various items, they generally have not been employed as part of a widely deployed business or household inventory management system. The development of such a system would constitute a major technological advance, and would satisfy long felt needs and aspirations in the inventory control and asset location industries.

### SUMMARY OF THE INVENTION

The present invention comprises methods and apparatus for deploying, placing, applying or installing RFIE) chips, antennas and related software onto a surface or object at the customers' premises. Radio Frequency Identification Devices or “RFIDs” are generally passive transponders which may be packaged as very small integrated circuits. When illuminated with radio frequency energy, passive RFIDs return some of the incident radio frequency energy to the energy source, where it may be detected. Each RFID may be configured to store a unique serial number or other characteristic identification information.

In one embodiment of the invention, RFIDs are loaded into a small canister for use inside a customer's printer. When the customer prints a document, photograph or other image on a sheet of paper, a special print head inside the printer forms or deploys an RFID onto the sheet of paper. The print head may place, eject or spray the chip onto the paper using an appropriate adhesive, ink or other bonding agent. The RFID's unique serial number can be used to locate the paper if it is lost or misplaced. A special RFID writer may also be used to store new or revised information in the RFID chip.

In one embodiment of the invention, RFIDs are created, prepared, assembled or configured at the customer's residential, office or business environment. The RFIDs are activated or made functional or usable employing small-scale, non-industrial, desktop-sized equipment. These products are generally produced in relatively small, non-industrial scale quantities by this personal, household, customer-based, or small-business equipment. They are consumed at that site, and not intended for resale.

An appreciation of the other aims and objectives of the present invention and a more complete and comprehensive understanding of this invention may be obtained by studying the following description of a preferred embodiment, and by referring to the accompanying drawings.

### A BRIEF DESCRIPTION OF THE DRAWINGS

FIGS. 1A & 1B supply views of RFIDs.

FIG. 2 exhibits how an RFID functions like a transponder, emitting a response when stimulated or illuminated by an interrogation signal.

FIG. 2A reveals details of a sniffer.

FIG. 3 reveals one embodiment of the invention, in which a specially configured print head inside a printer is able to apply an RFID to a sheet of paper.

FIG. 4 furnishes a detailed view of the RFID applicator shown in FIG. 3.

### A DETAILED DESCRIPTION OF PREFERRED & ALTERNATIVE EMBODIMENTS

I. RFIDs

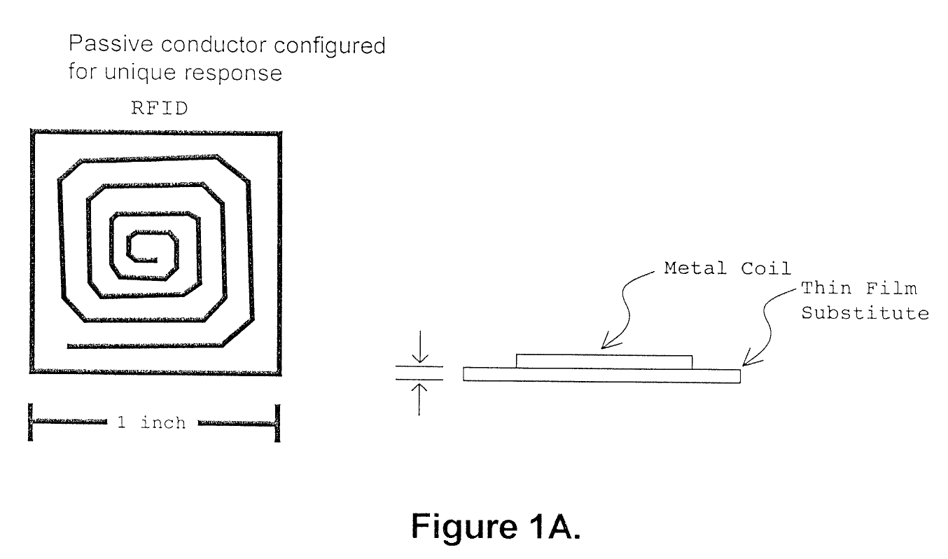

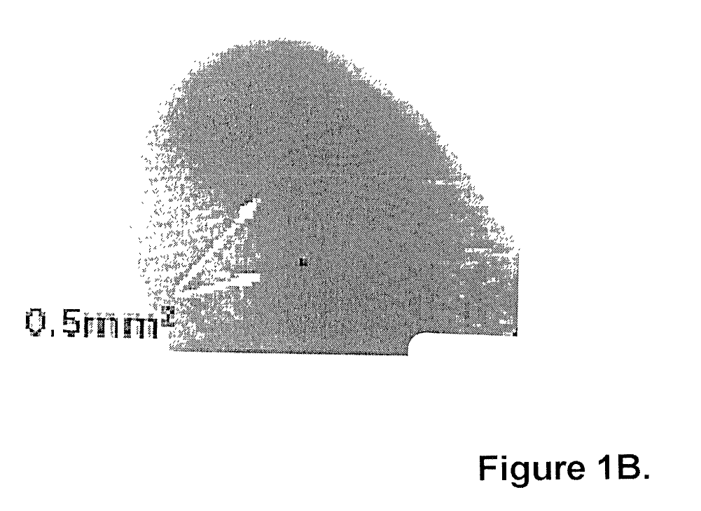

In general, RFIDs are transponders which emit a response signal when they are stimulated or illuminated by an external signal. Examples of RFIDs are shown in FIGS. 1A and 1B. The present invention may utilize active or passive RFIDs. FIG. 1A depicts an RFID comprising a conductive coil affixed to a non-conductive substrate, while FIG. 1B reveals an “RFID chip” perched upon a fingertip. In this Specification and in the claims that follow, the term “RFID” or “RFID chip” refer to any device that operates like a transponder, or that emits or reflects a portion of a signal or energy received from an external source. In this Specification and in the claims that follow, a transponder is a device which returns a signal or energy in response to an external stimulus or interrogation signal. An RFID, RFID chip or transponder may be complete and functional by itself, or may require a separate external antenna. Such an antenna is generally formed from a conductive material. Although one preferred embodiment of the invention utilizes passive RFIDs, the present invention may be practiced using any other type of chip, wireless sensor, detector, monitor, measurement component, medical probe or instrument, or some other industrial or consumer device; including active, battery-powered RFIDs or radio and sensor combinations. In general, a wireless sensor encompasses any means for collecting data or information and reporting data using some type of signal or energy to a remote location, computer or sniffer.

Although the preferred embodiment of the invention employs transponder devices which operate in the radio frequency bands, other transponders that may employ acoustic, ultrasonic, infrared or other optical signals or any other kind of sensible response may be utilized to practice the invention. In the simplest terms, an RFID takes some of the energy of an external signal, and converts it to a particular emanation or reflection that can be sensed by a detector. In this Specification and in the claims that follow, this detector is usually called a “sniffer.” This sniffer is usually automatic, and may be wired or wireless. The sniffer may be powered by batteries, or may require a standard cable and plug for a 110VAC electrical outlet. In one embodiment of the invention, the sniffer communicates wirelessly with a personal computer. In this Specification and in the claims that follow, the terms “RFID” or “transponder” generally comprise any device, apparatus, method or means, whether passive or active, which enables a first signal, wave or field to be varied, reflected, returned, emitted, emanated, or propagated in a way that enables the remote detection, sensing or identification of a particular item. Each RFID may be manufactured with a slightly different conductor pattern, so that each uniquely configured RFID in a set of many RFIDs will return a unique signal when they each encounter the external signal. The invention may also utilize RFIDs that are configured so that they all simultaneously respond to a single “all-hands” or “inventory” signal.

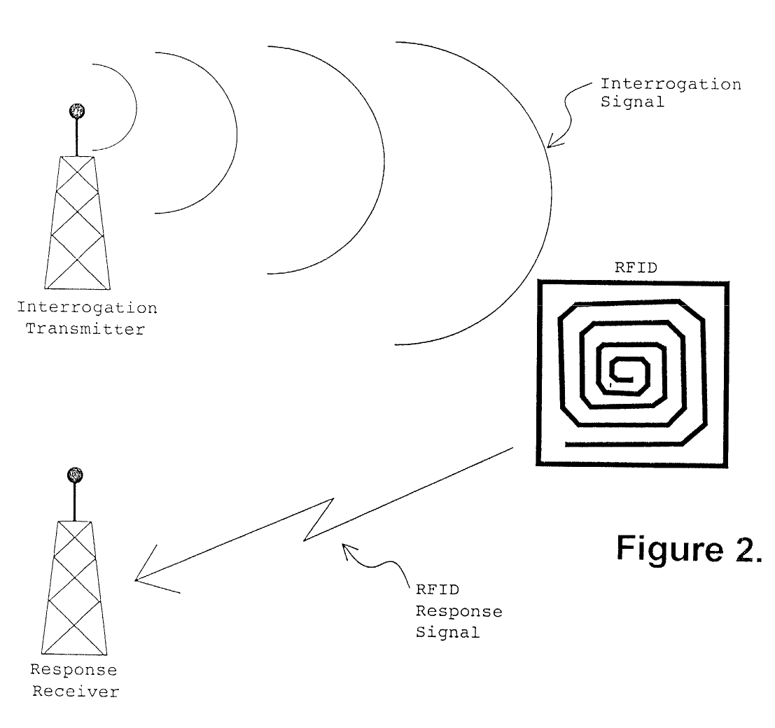

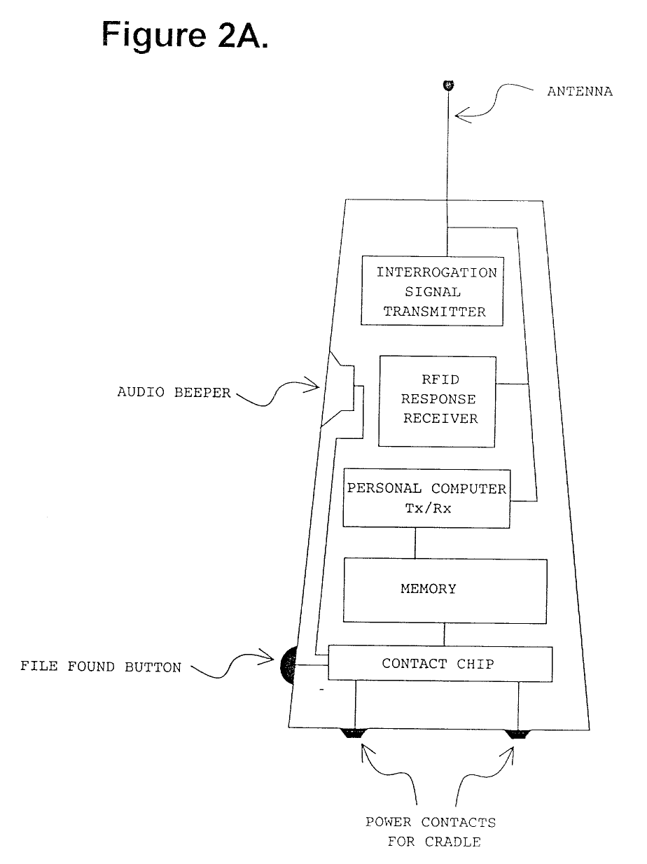

In one embodiment of the invention, a sniffer is a wireless device which emits a generally continuous “interrogation” radio frequency signal. The effective range of the sniffer may be a few feet, or may encompass a large range to incorporate a single room, an entire house, or a very large retail store. The area of operation of the sniffer comprises an interrogation zone. As shown in FIG. 2, a sniffer generally includes a transmitter that is capable of emitting this interrogation signal. When each RFID within the operating range of the sniffer emits its unique response, the sniffer detects all of these responses. In one embodiment of the invention, the sniffer is also capable of communicating wirelessly with a personal computer.

The personal computer is loaded with database software which associates the unique RFID serial number with identifying information about the object or item which is attached to a particular RFID label. In one embodiment, the database software generally comprises three portions or modules that are designed to perform three separate functions: data capture, database management and RFID interrogation. The data capture module collects, loads and processes data received from sniffers. The database management module manages, manipulates and stores data. The interrogation module provides instructions to the sniffer, and enables a user to find a particular RFID. Based on instructions from the computer user, the database software can instruct the sniffer to listen only for one particular response signal, which enables the user to find a particular item using the sniffer.

FIG. 2A is a schematic diagram showing the generalized circuit details of one embodiment of a sniffer. An external antenna is coupled to circuit stages which generate an interrogation signal, receive RFID response signals, and communicate with a personal computer. In alternative embodiments, the sniffer may communicate with other devices, such as personal digital assistants, televisions, telephones or kitchen appliances such as refrigerators. Other sections of the sniffer's internal circuitry may include a control chip, a memory, a rechargeable battery, and an audio beeper. In one embodiment, the sniffer is powered by a battery which receives power through contacts that mate with similar contacts on the sniffer's desktop cradle.

II. Preferred & Alternative Embodiments of the Invention

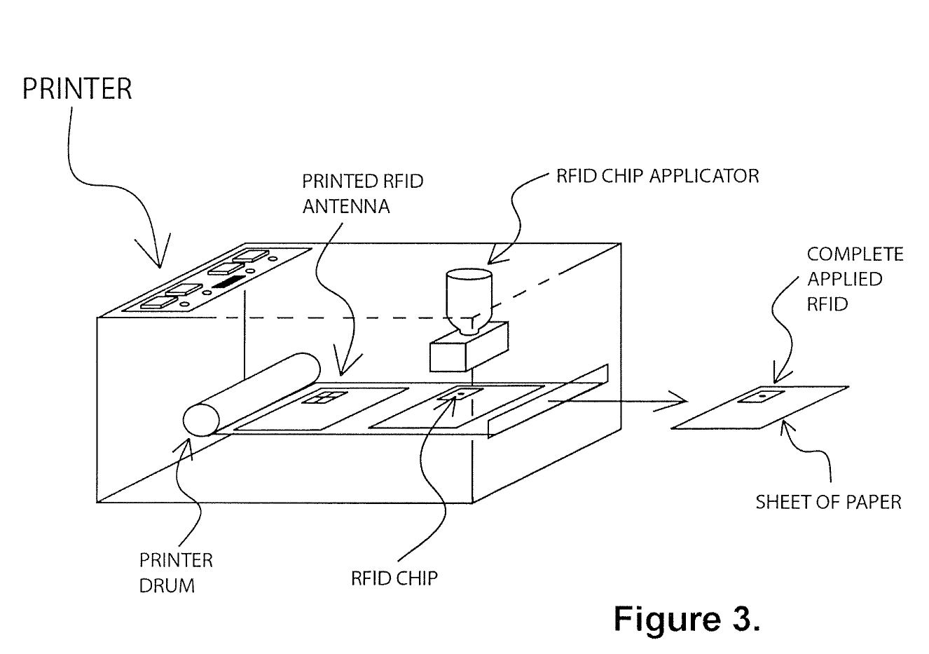

One embodiment of the invention is depicted in FIG. 3, which depicts a novel printer. This printer may be a laser, ink jet or any other type of printer which transfers toner, ink or some other image-forming agent to a sheet of paper, plastic, label, envelope, package or some other substrate or material. In this Specification and in the claims that follow, the term “substrate” includes any generally planar surface or generally flat object which may be imprinted with an image. In this Specification and in the claims that follow, the term “image” includes any text, pattern, photograph, or any other sensible arrangement of one material affixed or applied to a substrate below it.

One embodiment of the invention comprises a printer which includes a specially configured print head that deploys or applies RFID chips and associated objects to the same sheet of paper or substrate. As shown in FIG. 3, the printer first creates printed text, a photograph or other image using by a primary printer drum or head. After the conventional printing is completed, an RFID chip applicator conveys a single RFID chip from a storage canister, and ejects it onto or embeds it into the sheet of paper.

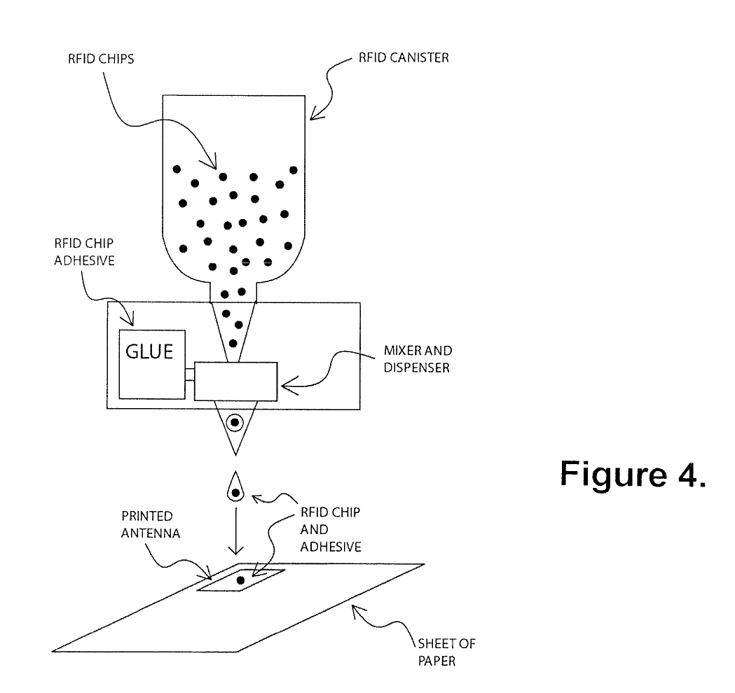

As shown in FIG. 4, the RFID may be deposited or sprayed from a dispenser which first mixes it with some other medium, such as a liquid glue, ink or other binding agent. The supply of RFIDs may be contained in an enclosure, may be serially deployed on a tape., or otherwise moved, conveyed, fed, injected, extruded, or provided to an applicator using any mechanical means that enables RFID chips to be adhered to a substrate.

In an alternative embodiment of the invention, it may be necessary or beneficial to also create an antenna that is mechanically connected or electro-magnetically coupled to the RFID chip. This antenna may be printed or sprayed using conductive ink. The antenna may be formed simultaneously with the application of the RFID, or may be formed in a separate step that occurs before or after the RFID application. In another alternative, the antenna may be pre-formed into the paper that is loaded into the printer.

In another embodiment, an RFID may be applied to an existing, printed document by feeding the existing document into the printer, and then directing the printer to only apply an RFID chip without printing a new image. The RFID applicator may be a stand-alone device whose only function is to apply an RFID chip to a surface or object.

The inventions described in this Specification will enable customers to apply RFIDs directly to printed documents, copies or pages received by facsimile. The novel RFID applying print head may be incorporated into printers, copiers, fax machines, scanners or any other machine that processes paper or other substrates. In another embodiment, RFID chips may be applied directly to a surface using a handheld device that resembles a gun, stapler or tape dispenser.

Once a customer has applied an RFID chip and perhaps an antenna to a document or other object such as a book, disc, tool, the RFID-bearing document or object may be used to practice the inventions described in a related co-pending U.S. patent application Ser. No. 10/151,470.

III. A Small-Scale Embodiment of the Invention

In one embodiment of the invention, RFIDs are created, applied, prepared, assembled or configured at the customer's residential, office or business environment; as opposed to being manufactured in a large industrial facility. The RFIDs are activated ormade functional orusable employing small-scale, non-industrial, desktop-sized equipment that resemble the modest printers and copiers that are already used in conventional home and office environments. These products are generally produced in relatively small, non-industrial scale quantities by this personal, household, customer-based, or small-business equipment. They are used or consumed at that site, and not intended for resale. In general, this specific, home-made or self-made embodiment requires the end-user's intervention or activity, as opposed to a product that is completely assembled and ready-to-use that is fabricated elsewhere.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the claims that follow. The various alternatives that have been disclosed above are intended to educate the reader about preferred embodiments of the invention, and are not intended to constrain the limits of the invention or the scope of claims.

What is claimed is:

1. A method comprising the steps of:
providing a generally planar substrate means;
conveying a transponder means to said generally planar substrate means;
said transponder means then adhering to said generally planar substrate means.

2. A method as recited in claim 1, in which said generally planar substrate means is capable of receiving a printed image.

3. A method as recited in claim 1, in which an image is printed on said generally planar substrate means prior to said transponder means being adhered to said generally planar substrate means.

4. A method as recited in claim 1, in which an image is printed on said generally planar substrate means after said transponder means is adhered to said generally planar substrate means.

5. A method as recited in claim 1, comprising the additional step of:
forming an RFID antenna on said generally planar substrate means.

6. A method as recited in claim 5, in which said antenna is mechanically connected to said transponder means.

7. A method as recited in claim 5, in which said antenna is electrically coupled to said transponder means.

8. A method as recited in claim 1, comprising the additional step of:
conveying said transponder means to said generally planar substrate means in a printer.

9. A method as recited in claim 1, comprising the additional step of:
conveying said transponder means to said generally planar substrate means in a copier.

10. A method as recited in claim 1, comprising the additional step of:
conveying said transponder means to said generally planar substrate means in a facsimile machine.

11. A method as recited in claim 1, comprising the additional step of:
conveying said transponder means to said generally planar substrate means in a scanner.

12. A method as recited in claim 1, comprising the additional step of:
conveying said transponder means to said generally planar substrate means in a stand-alone device whose only function is to apply said transponder means to said generally planar substrate means.

13. A method as recited in claim 1, in which said transponder means is adhered to said generally planar substrate means for use by the customer.

14. A method as recited in claim 1, in which said transponder means is adhered to said generally planar substrate means, and said transponder means is generally made usable by the customer.

15. A method as recited in claim 1, in which said transponder means is adhered to said generally planar substrate means for use in a residential environment.

16. A method as recited in claim 1, in which said transponder means is adhered to said generally planar substrate means for use in an office environment.

17. A method as recited in claim 1, in which said transponder means is adhered to said generally planar substrate means and is intended for use at the same site.

18. A method as recited in claim 1, in which said transponder means is adhered to said generally planar substrate means and is not intended for resale.

19. A method as recited in claim 1, in which a plurality of said transponder means are adhered to a plurality of generally planar substrate means in relatively small, non-industrial quantities.

20. A method as recited in claim 1, in which a plurality of said transponder means are adhered to a plurality of generally planar substrate means by the same person who will use said transponder means to locate objects owned by that person.

21. A method comprising the steps of:
providing a generally planar substrate means;
conveying a wireless sensor means to said generally planar substrate means;
said wireless sensor means then adhering to said generally planar substrate means.
